(19) United States
(12) Patent Application Publication
(10) Pub. No.: US 2023/0264165 A1
(43) Pub. Date: Aug. 24, 2023

(54) CATALYTIC REACTOR WITH IMPROVED PROPERTIES

(71) Applicant: CatIP B.V., Geldrop (NL)

(72) Inventors: John Wilhelm GEUS, Bilthoven (NL); Jacobus HOEKSTRA, Utrecht (NL); Marinus Franciscus Johannes EVERS, Heeze (NL)

(21) Appl. No.: 18/024,002

(22) PCT Filed: Aug. 27, 2021
(86) PCT No.: PCT/NL2021/050526

§ 371 Date: Feb. 28, 2023

(30) Foreign Application Priority Data
Aug. 28, 2020 (NL) 2026371

(51) Int. Cl. B01J 19/00; B01J 19/24; B01J 21/04; B01J 21/06; B01J 23/755; B01J 21/08; B01J 37/02; B33Y 80/00; B01J 37/34; B01J 6/00; C01B 3/16; B01J 37/12; B01J 37/16

(52) U.S. Cl. CPC B01J 19/0053; B01J 6/001; B01J 19/2485; B01J 21/04; B01J 21/063; B01J 21/066; B01J 21/08; B01J 23/755; B01J 37/0225; B01J 37/12; B01J 37/16; B01J 37/348; B33Y 80/00; C01B 3/16; C01B 2203/1023; C01B 2203/1058; C01B 2203/1076; C01B 2210/0004; C01B 2210/0006

(57) ABSTRACT

The invention is in the field of catalysis. In particular, the invention is directed to a catalytic reactor body, a method for the production of a catalytic reactor body and a use of a catalytic reactor body.

The invention provides a catalytic reactor body, comprising a circumferential reactor wall extending in a main fluid flow direction of the reactor body between a reactor inlet and a reactor outlet thereby forming a channel for conducting a fluid; and a reactor bed arranged in the channel and being integrally formed with the circumferential reactor wall, wherein the reactor bed forms a plurality of sub-channels for guiding the fluid from the reactor inlet to the reactor outlet, each sub-channel defining a predetermined fluid path between the reactor inlet and the reactor outlet and being configured for directing the fluid in a direction at least partly transverse to the main flow direction.

### BACKGROUND OF THE INVENTION

The invention is in the field of catalysis. In particular, the invention is directed to a catalytic reactor body, a method for the production of a catalytic reactor body and a use of a catalytic reactor body.

Activity and selectivity are important factors that influence the efficiency of a catalytic process. Activity and selectivity can be influenced by many factors. One of these factors is the temperature at which the reaction takes place. For instance, performing a catalytic reaction at a too high temperature can lead to a loss in selectivity, such as in case of the production of ethylene oxide from ethylene and oxygen. A shift in the selectivity of a catalytic reactor is also exemplified by the selective oxidation of hydrogen sulfide to elemental sulfur. At higher temperatures, the oxidation of gaseous sulfur leads to sulfur dioxide, which is not desired. Too high reaction temperatures can also lead to a shift in the thermodynamic equilibrium in an unfavorable direction, such as in case of ammonia and methanol synthesis. The risk of running a catalytic reaction at too high reaction temperatures mainly occurs with exothermic reactions, in which heat is generated during the reaction. The typical solution to prevent this is to limit the conversion per pass through the reactor and to separate the desired reaction product after each pass through the reactor by cooling the flow exiting the reactor. Then, the unreacted gas flow is recirculated after addition of fresh feed. When the reaction product cannot be easily separated from the flow, a heat exchanger has to be installed behind the first reactor and the flow is passed through a second reactor. An example is the oxidation of sulfur dioxide to sulfur trioxide with the production of sulfuric acid.

On the other hand, running a catalytic reaction at a too low reaction temperature, which can typically occur in case of an endothermic reaction, may also be undesirable, because it can for example lead to a too low activity. Therefore, recirculation of the flow to the reaction zone is sometimes also required for endothermic reactions.

The thermal conductance of typical fixed catalyst beds is fairly low. One of the reasons for that is that traditional fixed catalyst beds typically consist of a packed bed of individual catalyst particles, through which heat transfer is not very efficient. Such a packed bed of solid catalysts that is employed with, e.g. gaseous reactants must expose a high active surface area per unit volume to the gas phase to achieve technically desired high conversions per unit volume. However, a high surface area implies using small particles, and passing a gas flow through a catalyst bed of stacked small particles leads to a high pressure drop, which is undesired. Furthermore, this high pressure drop can lead to catalyst bodies blowing out of the reactor, or to the gaseous reactants ‘channeling’ through the catalyst bed. When channeling occurs, the catalyst bodies within small volumes in the catalyst bed are not stationary, but are fluidized, and most of the gas flow passes through the small volume of the sections where the catalyst bodies are fluidized.

An approach used in the art to achieve a catalyst bed with high surface area, while limiting the pressure drop is to use catalyst bodies of at least 5 mm that are highly porous in order to expose a large catalytically active surface area to the reactants. However, those porous catalyst bodies exhibit a low thermal conductance, because the thermal conductance of the stationary gas within the pores of the catalyst is low. With exothermic reactions performed with a traditional packed catalyst bed, it is therefore not possible to limit the increase in temperature inside the reactor by cooling the walls of the reactor when the conversion of the reactants is raised.

A possibility to improve thermal conductance with exothermic and endothermic reactions is to employ a fluidized bed reactor in which transport of thermal energy to a cooling or heating coil can be performed more easily. Fluidized catalyst beds are employed in cases where the catalyst has to be transported continuously from one reactor to another reactor, for instance in fluid catalytic cracking processes, but cannot be used for all catalytic processes. Since the catalyst bodies in a fluidized bed are of a size of the order of 100 µm, the transport of reactants and reaction products is relatively fast. However, due to gas bubbles passing through fluidized beds the conversion is generally not complete. Furthermore it is required to have a catalyst of a sufficient attrition resistance available.

With catalytic reactions involving a liquid phase, the need for a high thermal conductance of the reactor may be less apparent than for gas-phase reactions, because the heat transfer with liquids is usually much more favorable than with gases. However, a problem with liquid phase reaction is that molecular transport within a liquid phase proceeds much more slowly compared to the gas phase. In heterogeneous catalysis, the catalytic reaction typically takes place at the surface of the solid catalyst. However, in the pores of highly porous catalyst bodies, where the liquid is stagnant, molecular transport through the pores and to and from the surface of the solid catalyst may be particularly slow. Therefore, when a catalyst bed of larger porous catalyst bodies is used to prevent channeling and/or bypassing, only the external edge of the catalyst bodies contributes to the catalytic reaction. Much smaller catalyst bodies can be employed in liquid slurries, but this requires an additional filtration or centrifugation step to separate the catalyst from the reaction products.

Catalytic reactions in which a reaction between a gaseous and a liquid or dissolved reactant are to be performed often present special problems. Since the molecular volume of the gas phase is much larger than that of the liquid or dissolved phase, a sufficiently rapid delivery of the gaseous reactant(s) calls for special measures. When the solubility of the gaseous reactant(s) within the liquid is limited, the low concentration of the molecules of the gaseous reactant(s) in the liquid can lead to selectivity problems. Many catalytic hydrogenations performed in a liquid with a solid suspended catalyst exhibit a poor selectivity.

Another problem of packed catalyst beds is that the catalyst bodies are not well accommodated to the wall of the reactor. This results in low heat transfer between the reactor wall and the catalyst body, but may also lead to a considerable bypassing, or slip, of the reactants without reaction along the wall of the reactor. Accordingly, the length of the catalyst bed must be relatively large to achieve the desired conversion. Therefore, these reactors have to be made larger and are therefore relatively heavy.

Efforts have been made to develop catalytic reactors with improved thermal conductance, but it remains challenging to provide catalytic reactors that combine high thermal conductance with other favorable properties such as high molecular transport and low pressure drop. In addition, such catalytic reactors are often heavy, complicated and difficult to produce.

An approach for improving thermal conductance of catalytic reactors is to make catalyst beds by sintering of metal bodies. Such a reactor is described for example in EP-A-2 228 340. The reactor is used to catalytically convert methanol with air oxygen to carbon dioxide and water in one part of the reactor, while generating heat. In another part of the reactor methanol is catalytically converted to hydrogen and carbon monoxide, followed by conversion of the carbon monoxide with water to hydrogen and carbon dioxide. The heat generated in the first part of the reactor is used to produce the elevated temperature required in the second part of the reactor. The catalyst beds for both reactions are made of sintered metal particles which are in heat exchanging relationship for a rapid transport of the thermal energy.

In US-A-2018/0 333 703 a metal monolith is described. This metal monolith is used in a reverse flow reactor for methane steam reforming. A hot flow produced by the oxidation of methane with oxygen heats the monolith. When the reactor has as a high enough temperature, a flow of methane and steam is passed in the opposite direction through the reactor and the endothermic reaction to hydrogen and carbon monoxide proceeds until the temperature has dropped to a level where the rate of reaction is too low and the next heating cycle is initiated. The metal monolith of US-A-2018/0 333 703 is wrapped in an alumina cloth to prevent bypassing, and placed in a quartz tube, which means that conduction of heat from the outside of the reactor to the catalytically active surface is not optimal.

WO-A-2019/228795 discloses a structured catalyst which is heated using resistance heating. Because the structured catalyst itself is heated using resistance heating, instead of being heated using a heat source outside the reactor, good conduction of heat between the structured catalyst and the reactor wall is not required.

In US-A-2003/0 012 711, a reaction vessel containing catalyst material in the shape of a monolith that is placed in the reaction vessel is disclosed.

Reactors with a catalyst bed made of sintered metal bodies, however, have some disadvantages. One of the disadvantages is the weight of such reactors. The weight of sintered catalyst beds can be lowered by using bodies of a lighter metal, such as aluminum. However, the relatively low melting point of aluminum makes this material not ideal for catalytic reactors.

Another disadvantage of the catalytic reactors that are made of sintered metal bodies is that the flow properties are difficult to control. The pore structure of the sintered catalyst bed is dependent primarily on the packing of the metal bodies before sintering, which can only be designed or customized to a certain degree. Because of that, there is often a trade-off between the length of the reactor required to achieve a certain conversion, pressure drop, and/or weight of the reactor.

An object of the invention is to provide a catalytic reactor with high thermal conductance.

Another object is to provide a catalytic reactor which reduces slip or bypass of reactants along the catalyst bed.

Another object of the present invention is to provide a catalytic reactor which addresses one or more of the problems associated with catalytic reactors known in the art.

### BRIEF SUMMARY OF THE INVENTION

In accordance with the present invention there is provided a catalytic reactor body, comprising a circumferential reactor wall extending in a main fluid flow direction of the reactor body between a reactor inlet and a reactor outlet thereby forming a channel for conducting a fluid; and a reactor bed arranged in the channel and being integrally formed with the circumferential reactor wall, wherein the reactor bed forms a plurality of sub-channels for guiding the fluid from the reactor inlet to the reactor outlet, each sub-channel defining a predetermined fluid path between the reactor inlet and the reactor outlet and being configured for directing the fluid in a direction at least partly transverse to the main flow direction.

In another aspect of the invention, there is provided a method for the production of a catalytic reactor body as described herein, comprising the step of additive manufacturing of a body comprising a plurality of sub-channels.

In another aspect of the invention, there is provided the use of a catalytic reactor body as described herein for catalyzing a chemical reaction.

The catalytic reactor body described herein has a high thermal conductance and facilitates contact of a fluid flow with the internal surface of the reactor body. The dimensions and shape of the predetermined fluid path can be optimized such that the reactor body has good properties in terms of pressure drop and weight. The geometry of the sub-channels can be chosen such that collisions between molecules in the fluid flow and the catalyst surface are achieved. This means that a high activity can be reached for relatively small reactors and that light-weight catalytic reactors can be produced.

The circumferential wall of the catalytic reactor body can withstand high temperatures and pressures, and therefore, the circumferential wall reactor body can serve as the reactor wall.

Because the reactor bed is integrally formed with the circumferential reactor wall, there is not only good heat transfer between different regions of the reactor bed, but also between the reactor bed and the outside of the reactor. Because of that, the temperature of the catalytic reactor can be efficiently regulated by heating or cooling the reactor wall.

### BRIEF DESCRIPTION OF THE DRAWINGS

FIG. 1 shows photographs of various amounts of catalytic material (0.5 wt.% Pd/SiO₂) introduced in the glass catalytic reactor for the catalytic combustion of toluene to CO₂ and H₂O.

FIG. 2 shows the design of structure 1 with the zig-zag sub-channels (FIGS. 2a and 2b), a photograph of a stainless steel 3D-printed (using selective laser sintering) reactor disk with this structure (dimensions: 4.4 cm in diameter, 2 cm length) (FIG. 2c), and the reactor disk after application of a silicone rubber coating (FIG. 2d). In FIG. 2b, one secondary sub-channel arranged for accommodating a second fluid or monitoring the temperature with a thermocouple can be seen, as well as three holes for receiving an alignment organ.

FIG. 3 shows the catalytic conversion of toluene using the reactor disk shown in FIG. 2.

FIG. 4 shows an SEM-BSE (back-scattered electron) image of the Pd/Pt catalysts prepared on the stainless steel reactor disk using a galvanic exchange procedure (scale bar 3 µm).

FIG. 5 shows the catalytic conversion of toluene with a stainless steel reactor disk provided with a Pd/Pt combustion catalyst prepared by galvanic exchange.

FIG. 6 shows a photograph of a reactor disk in an Osborne-Reynolds set-up. The colored solution is introduced via the center of the disk. Due to mixing with the flow of water and turbulence within the reactor disk, a homogeneously colored solution exits the reactor disk.

FIG. 7 shows the catalytic conversion of toluene using a Ti-6Al-4V reactor disk provided with a Pd catalyst prepared by electroless deposition.

FIGS. 8a, 8b, 8c, and 8d shows the design of structure 2 with the sheet-pile sub-channels, a photograph of a stainless steel 3D-printed (using selective laser sintering) reactor disk with this structure (dimensions: 4.4 cm in diameter, 2 cm length), and a photohgraph of a stainless steel reactor disk produced via fused deposition modeling using a polyoxomethylene polymer highly filled with stainless steel powder. In FIGS. 8a, 8b, 8c, and 8d, one secondary sub-channel arranged for accommodating a second fluid or monitoring the temperature with a thermocouple can be seen, as well as three holes for receiving an alignment organ.

FIG. 9 shows the conversion of toluene over catalytic reactor bodies according to the invention and over a commercially available monolithic catalytic car converter.

FIG. 10a shows the conversion of toluene over a catalytic reactor body with narrow sub-channels and a catalytic reactor body with wider sub-channels, respectively. In FIGS. 10b and 10c, photographs of the catalyst reactor bodies with narrow (FIG. 10b) and wider (FIG. 10c) sub-channels are shown.

### DETAILED DESCRIPTION OF THE INVENTION

According to the invention there is provided a catalytic reactor body, comprising a circumferential reactor wall extending in a main fluid flow direction of the reactor body between a reactor inlet and a reactor outlet thereby forming a channel for conducting a fluid; and a reactor bed arranged in the channel and being integrally formed with the circumferential reactor wall, wherein the reactor bed forms a plurality of sub-channels for guiding the fluid from the reactor inlet to the reactor outlet, each sub-channel defining a predetermined fluid path between the reactor inlet and the reactor outlet and being configured for directing the fluid in a direction at least partly transverse to the main flow direction.

As used herein, the phrase ‘internal surface’ refers to the inside of the circumferential wall, together with the walls of the plurality of sub-channels.

“Circumferential reactor wall” refers to a wall that extends around the reactor bed. The cross section of the circumferential reactor wall may be circular, resulting in a circumferential reactor wall having a cylindrical shape, but other shapes are also possible. For instance, it is also possible that the cross section of the circumferential reactor wall is a square, resulting in a cuboid shape, or a square with rounded edges, or another shape.

As used herein, the reactor bed being integrally formed with the circumferential reactor wall means that the reactor bed and the circumferential reactor wall together form one piece, and cannot be separated from each other without using destructive methods such as cutting. For instance, this can be achieved by manufacturing the reactor bed and the circumferential reactor wall as a single piece, for instance using additive manufacturing. However, a reactor bed being integrally formed with a circumferential reactor wall can in principle also be achieved by separately providing a circumferential reactor wall and a reactor bed, and joining them together, for instance using welding. Nonetheless, the thermal conductivity of a piece can be negatively influenced by the presence of joints, such as welds. It is therefore preferred that the reactor bed and the circumferential reactor wall are produced as a single piece, for instance using additive manufacturing. It is also preferred that there is no joint or weld between the reactor bed and the circumferential reactor wall.

Surprisingly, with the reactor body according to the present invention, the size of the catalytic reactor body required to achieve a given conversion of a reactor body according to the invention can be much smaller than that of conventional fixed bed catalytic reactors. Therefore, the weight of the reactor can be appreciably lower.

Without wishing to be bound by theory, it is believed that the reactor bed arranged in the channel being integrally formed with the circumferential reactor wall strongly increases the thermal conductance of the reactor body.

A further advantage of the reactor body according to the invention is that slip or bypass of the reactor bed is prevented. With usual fixed bed reactors the catalyst bodies are not well accommodated to the wall of the reactor, which leads to a considerable slip of the reactants without reaction along the wall of the reactor. Accordingly the length of the catalyst bed must be relatively large to achieve the desired conversion. With sintered solid body reactors the bypass along the wall of the reactor cannot proceed, and therefore the size of the catalytic reactor body required to achieve a given conversion of a reactor body according to the invention can be much smaller than that of conventional fixed bed catalytic reactors. Therefore, the weight of the reactor can also be appreciably lower.

In view of the literature the finding that an efficient mixing of the flow through the reactor and, hence, an intensive contact with a catalytically active surface can be achieved in a relatively short reactor by providing sub-channels that are configured for directing the fluid in a direction at least partly transverse to the main flow direction is surprising.

Another advantage is the high thermal conductance of the reactor. An efficient transport of thermal energy into or out of the reactor can achieve readily the required conversion without much recirculation of the flow through the reactor and removal of the reaction product(s) resulting from a pass through the reactor. Another considerable advantage is that the temperature over the catalyst bed can be maintained more easily within levels where the conversion is higher and the selectivity of the catalytic reaction is more favorable.

Because the reactor bed is integrally formed with the circumferential reactor wall, there is not only good heat transfer between different regions of the reactor bed, i.e., axial heat conductance, but also good heat transfer between the reactor bed and the outside of the reactor, i.e., radial heat conductance. Because of that, the temperature of the catalytic reactor can be efficiently regulated by heating or cooling the reactor wall.

Typically, the circumferential wall of the catalytic reactor body can withstand high temperatures and pressures, and therefore, the circumferential wall of the catalytic reactor body can serve as the reactor wall. It is not necessary to place the reactor body inside a tube or other enclosure for mechanical strength, which would have a negative effect on the thermal conductance.

Another advantage is that the predetermined channels of the reactor body can be optimized. With the reactors containing sintered metal bodies according to the present state of the art, the transport of the reactants through the structure of sintered bodies is not optimal. The stacking of the metal bodies in the reactor does not lead to a flow pattern of the reactants that promotes transport to the catalytically active surfaces. The possibilities to control the stacking of the solid bodies before sintering together within the reactor are limited. The void fraction of the sintered bodies has to be relatively high to prevent a high pressure drop during passing the reactants through the reactor. The proportion of the flow of the reactants through the structure that is turbulent is limited and thus the molecular transport to the catalytically active surfaces is also relatively slow.

One of the main disadvantages of sintered metal reactors, the weight of the reactor, is obviated by the reactor body of the invention, since the sub-channels with a defined path bring about that less material is needed in the construction of the reactor. In that way, the catalytic reactor body according to the invention combines low pressure drop with maximizing the catalytic surface area.

Preferably, the catalytic reactor body is made by additive manufacturing. Additive manufacturing may also be referred to as 3D-printing.

By using additive manufacturing, the size and the shape of the metal bodies and that of the voids between the metal bodies can be controlled much more widely and accurately. Computer programs and simulations can be employed to achieve structures optimal for specific catalytic reactions. Therefore, by using additive manufacturing, the sub-channels can be designed in such a way that contact of the fluid flow with the catalyst surface is improved, such that a relatively small length of the reactor is sufficient to achieve a technically required conversion. Due to the design of the sub-channels, at the same time, other flow characteristics, such as pressure drop can also be optimized.

The catalytic reactor body can be made of a wide variety of materials. In embodiments, the reactor body is constructed of a metal or metal alloy having a high thermal conductivity, in order to further promote the thermal conductance of the reactor. Also, metals or metal alloys typically combine high thermal conductance with good mechanical strength.

Preferably, the catalytic reactor body comprises or consists of materials selected from the group consisting of steel, copper, aluminum, nickel, titanium, zirconium, and alloys comprising these metals. Examples of alloys that can be used include Inconel® nickel alloys, which have a good resistance against heat, pressure, and corrosion.

The material of which the catalytic reactor body is made can provide catalytic activity itself, or it can serve as a support material for catalytically active materials, or both.

In embodiments, the internal metal surface of a metal reactor body is covered by a layer of a ceramic material, preferably comprising silicon dioxide, titanium dioxide, and/or zirconium dioxide. The metal reactor body can be covered by an oxide layer, onto which a catalytically active material can be deposited. Such an oxide layer may comprise one or more oxides that are highly porous, i.e., oxides with a high specific surface area. Such oxide layers may be obtained by oxidation of the internal metal surface of the catalytic reactor body. For instance, titanium or zirconium or alloys of such metals can be oxidized, thereby forming an oxide layer comprising titania and/or zirconia. This oxide layer may be porous.

Especially in the case of a titanium catalytic reactor body, the internal surface of the catalytic reactor body may advantageously be oxidized, resulting in a titanium dioxide surface layer onto which catalyst particles can be deposited. Titanium dioxide is a reducible oxide, which, when used as a support for catalyst particles, can contribute to preventing formation of carbon deposits, or coke, during catalytic reactions. For instance, when Ni catalyst particles on a titanium dioxide support are used in methane steam reforming, less coke formation can be observed than with other support materials.

In embodiments, for instance in case the catalytic reactor has to be able to withstand more elevated temperatures or chemically aggressive atmospheres, the reactor comprises or consists of a suitable ceramic material, such as, corundum, (aluminum-magnesium) spinel or zirconia. The thermal conductivity of the ceramic non-porous solids is still appreciable.

Catalytically active material may be deposited on the internal surface of the catalytic reactor body, for instance on the metal or ceramic material that the reactor is made of, or on the layer of a ceramic material. The catalytically active material may be applied as a thin layer, or as individual particles.

Depositing catalytically active material onto the internal surface can for instance be done when the catalyst is a precious metal, in which case it would be too expensive to produce the reactor body entirely or for a large part of this precious metal. Other cases where depositing catalytically active material may be useful is when the catalytic activity depends on the interface between two materials, e.g. the interface between the internal surface of the reactor body and the material deposited thereon. Also, depositing individual particles onto the internal surface of the reactor body may provide a larger active surface area than when the internal surface is entirely made of the catalytically active material. A catalytically active component can be applied into or onto the oxide layer, which may be a porous oxide layer, using procedures known in the art. For instance, when the oxide layer on the metal assumes an electrostatic charge, a precursor for a catalytically active material can be applied by impregnation with water with a (complex) ion of an opposite electrostatic charge. Deposition-precipitation can also be employed, as well as impregnation with a solution comprising the active precursor the viscosity of which increases during evaporation of the solvent, as is the case using e.g. citrate solutions. Other methods, such as washcoating may also be applied in order to deposit catalytically active materials.

It has been established that also application of a catalytically active metal on the metal of the reactor by electrochemical exchange leads surprisingly to a structure that is highly catalytically active. Application of copper on titanium, iron or nickel alloy surfaces is highly interesting, for instance also for the synthesis and decomposition of methanol. For oxidation of poisonous or badly smelling gases a very active composition was produced by electrochemical exchange of platinum or palladium.

In embodiments, the internal surface of the reactor body has been made catalytically active by electrochemical exchange with another element or elements are a special embodiment of the present invention.

It is not always necessary to deposit catalytically active particles onto a metallic catalytic reactor body. Surprisingly, the inventors found that construction of the reactor according to the invention from a metal that is catalytically active may lead to a catalytic activity that is sufficient for performing industrially important reactions. Therefore, in embodiments, the reactor body according to the invention is made from a catalytically active metal or alloy. For instance, a reactor body manufactured from metallic copper provides excellent thermal conductance properties, but at the same time, the copper can also provide catalytic activity for the synthesis and decomposition of methanol, provided that components poisoning the copper catalyst (such as sulfur containing compounds) are previously removed by, e.g., zinc oxide.

Without wishing to be bound by theory, it is believed by the present inventors that the remarkable catalytic activity and/or conversion that can be achieved using the catalytic reactor body according to the invention is caused by the sub-channels being configured for directing the fluid in a direction at least partly transverse to the main flow direction. It is believed that by directing the fluid in a direction at least partly transverse to the main flow direction, the number of collisions between molecules in the fluid flow and the internal surface of the reactor body increases. Because in heterogeneous catalysis, reactions typically take place at the interface between the solid catalyst bed and molecules in the fluid flow, increasing the number of collisions between fluid flow molecules and the internal surface of the reactor body leads to a higher conversion. In other words, the chance that a fluid molecule is able to travel through a reactor body of a certain length without colliding with, or without being able to react at the catalytically active surface is decreased. Therefore, the chance that a certain molecule of the fluid flow is converted at a catalytically active site is higher. The inventors believe that heat transfer between the fluid flow and the reactor body is also improved as a result of the sub-channels being configured for directing the fluid in a direction at least partly transverse to the main flow direction.

Because the sub-channels are configured for directing the fluid in a direction at least partly transverse to the main flow direction, the tortuosity, which is defined herein as the length of each sub-channel divided by the shortest length between the reactor inlet and the reactor outlet, is higher than 1. Preferably, the tortuosity is 1.1 or higher, more preferably 1.3 or higher, even more preferably 1.5 or higher. For instance, the tortuosity of the sub-channels is 1.1-5, or 1.2-3.

A factor that is important for the number of collisions between fluid flow molecules and the internal surface of the catalytic reactor body is the turbulence of the flow. A more turbulent flow will, unlike a laminar flow, result in more collisions between fluid flow molecules and the internal surface of the catalytic reactor body, and therefore, in improved catalytic performance. Directing the fluid in a direction at least partly transverse to the main flow direction results in an increase in turbulence of the flow. Another factor that influences turbulence of the flow is the diameter of the sub-channels. When the sub-channels are very narrow, the turbulence of the flow through the sub-channels is negatively affected. Therefore, the diameter of the sub-channels is preferably 1 mm or higher, more preferably 1.3 mm or higher, even more preferably 1.5 mm or 2 mm or higher. In case the cross section of a sub-channel is not circular, but has an elongation direction and a width direction, which is for instance the case in sub-channels with an elliptic or rectangular cross section, the above-mentioned preferred sub-channel diameters relate to the diameter of the sub-channel in the width direction of the cross section. As an example, in case of sub-channels with a rectangular cross section, said rectangular cross section may have dimensions of 1 × 4 mm, or 2 × 6 mm (width × length), meaning that the diameter of the sub-channel in the width direction is 1 mm or 2 mm, respectively.

The sub-channels of the catalytic reactor body can have a wide variety of configurations, as long as they are configured for directing the fluid in a direction at least partly transverse to the main flow direction. They can for instance be straight channels, that are placed at an angle with respect to the main flow direction. Other options include, for instance, curved channels.

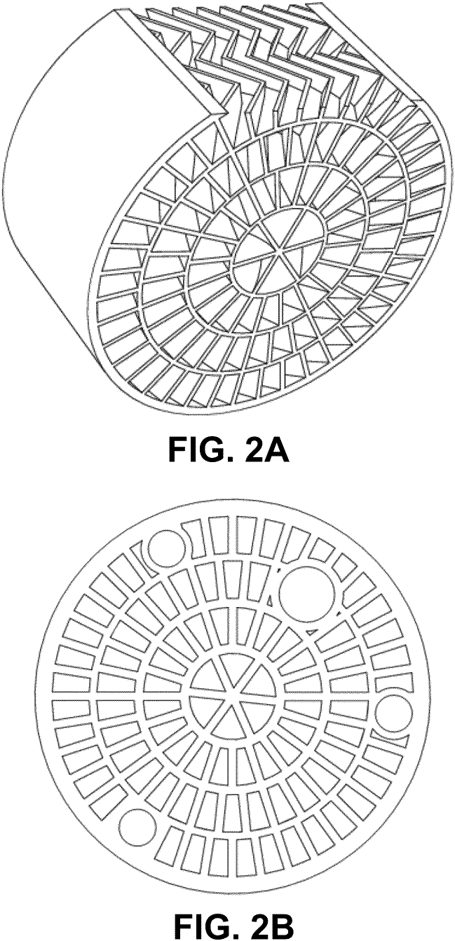

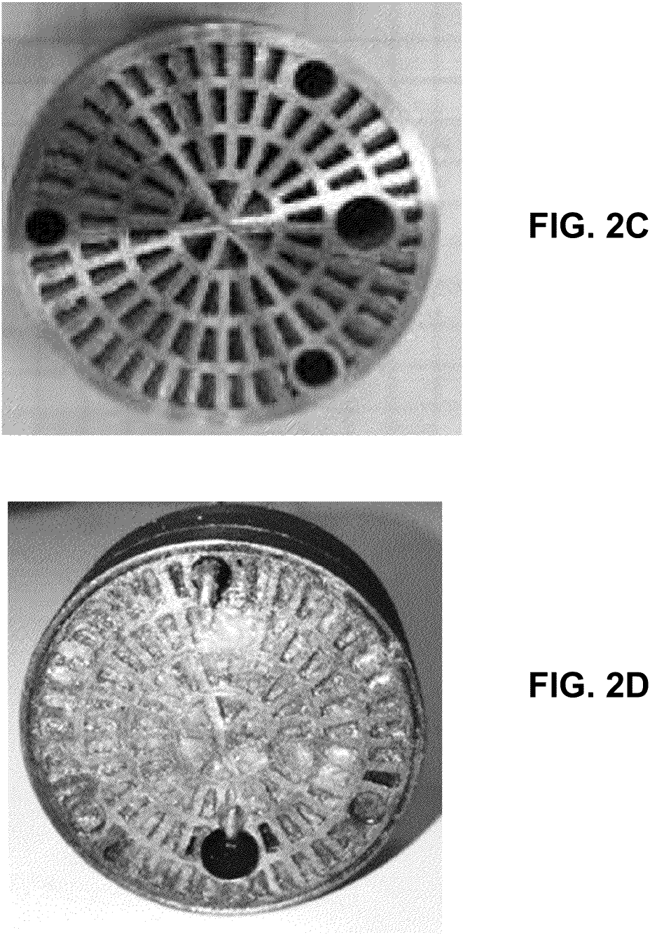

An option is that the sub-channels follow a zig-zag pattern, comprising sections that are oriented at an angle with respect to the main flow direction. FIGS. 2 shows a schematic view of a catalytic reactor body according to an embodiment of the invention with sub-channels that follow a zig-zag pattern.

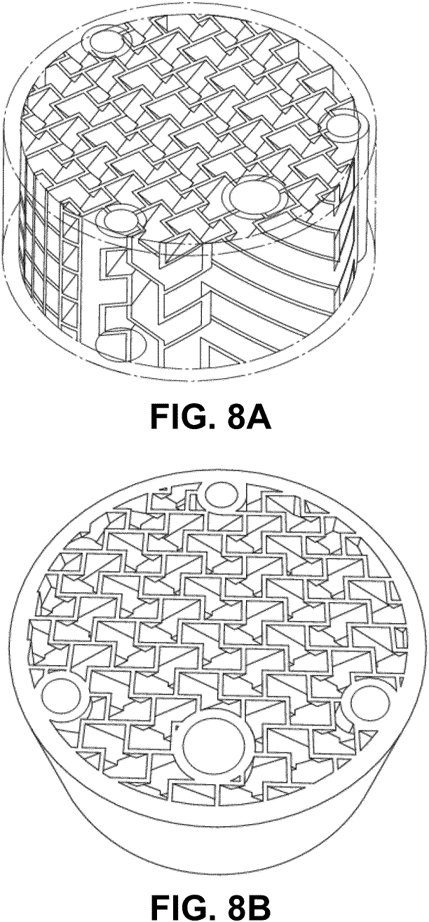

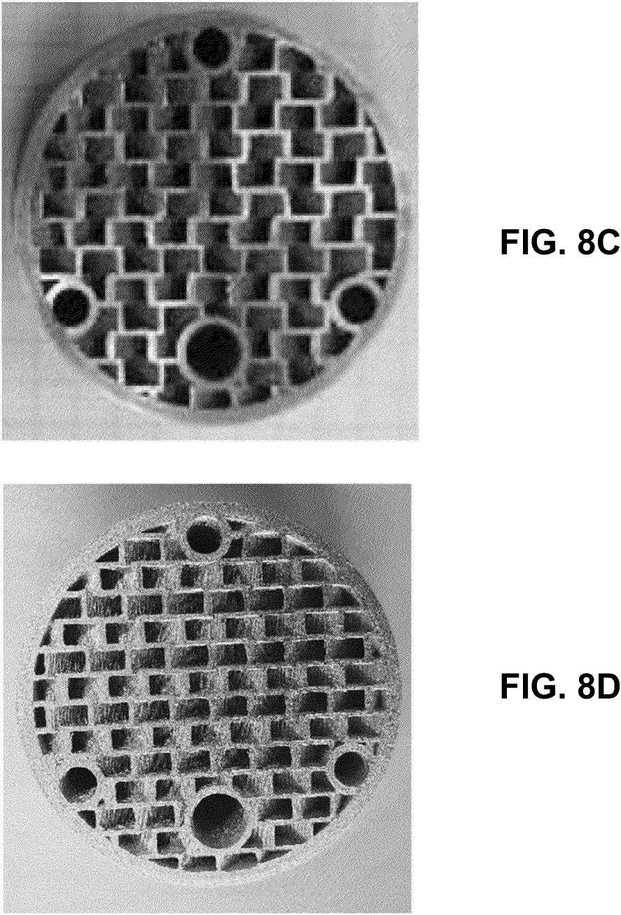

Another possible pattern can be described as channels which are shaped as if they were formed by a cross-wise alternating stack of multiple corrugated sheet-pile walls extending between opposite sides of the circumferential reactor wall. FIGS. 8A and 8B show a schematic view of a catalytic reactor body according to an embodiment of the invention with sub-channels that follow such a cross-wise alternating sheet-pile pattern.

In embodiments, the sub-channels of the catalytic reactor body comprise one or more sections oriented at an angle of 20 to 70 degrees with respect to the main flow direction.

The catalytic reactor body may further comprise one or more secondary sub-channels arranged for accommodating a second fluid, wherein the second fluid is preferably a heat transfer fluid. In this way, the temperature of the catalytic reactor body can be controlled even better, which can have a positive effect on factors as the activity and selectivity of the reaction. To improve the transport of thermal energy the channels for the heat transport are preferably manufactured as a metal structure to facilitate the transport of thermal energy into or out of the reactor. Alternatively or additionally, a thermocouple can be inserted in one or more of the secondary sub-channels in order to monitor the temperature inside the catalytic reactor body.

Using the catalytic reactor body of the invention, high conversions can be obtained using only a short reactor. Advantageously, a short catalytic reactor body is typically lighter than a long reactor body. Preferably, the catalytic reactor body has a length in the direction of the main fluid flow of 0.5 to 50 cm. More preferably, the catalytic reactor body has a length in the direction of the main fluid flow of 0.5 to 30 cm, such as 1 to 10 cm, or even 1 to 5 cm.

If a higher active surface area is desired, the internal surface area of the reactor body can be made rough. If the catalytic reactor body is made using additive manufacturing, it will typically have some roughness originating from the additive manufacturing process. Furthermore, in case of a metal reactor body, oxidizing and subsequently reducing the internal surface area surprisingly may lead to additional roughness of the internal surface of the reactor body, thereby increasing the catalytically active surface area. The amount of surface roughness can be expressed by the S_{dr} parameter, also known as the developed interfacial area ratio. This parameter is a value for the additional surface area resulting from surface roughness, compared to a completely smooth surface. The S_{dr} parameter is defined in ISO 25178 by the following formula.

$${S}_{d r} = \frac{1}{A} \left[{∬}_{A} \left(\sqrt{\left[1 + {\left(\frac{δ z \left(x , y\right)}{δ x}\right)}^{2} + {\left(\frac{δ z \left(x , y\right)}{δ y}\right)}^{2}\right]} - 1\right) d x d y\right]$$

wherein A is the definition area. For example, the S_{dr} parameter of a completely smooth surface is 0, whereas the S_{dr} parameter for the same surface having twice the surface area of the completely smooth surface due to surface roughness is 1. Preferably, the S_{dr} parameter of the internal surface of the catalytic reactor body is 0.5 or more, more preferably 0.7 or more, or 0.8 or more. In embodiments, the S_{dr} parameter may even be 1 or more, such as 1.5 or more.

The fact that the bypass, or slip, of the reactants along the wall of the reactor is prevented by the reactor bed being integrally formed with the circumferential reactor wall, brings about that relatively short reactors can provide the desired conversion.

The catalytic reactor body can be light weight, i.e., the amount of solid material present per unit volume can be kept low, without negatively affecting the length of the reactor needed to achieve the desired conversion. Preferably, the amount of solid material present per unit volume is 0.7 cm³ per cm³ or less, more preferably 0.5 cm³ per cm³ or less, such as 0.4 cm³ per cm³ or less or even 0.3 cm³ per cm³ or less of the reactor body. Typically, the amount of solid material present per unit volume is more than 0.1 cm³ per cm³.

Because the shape and dimensions of the channels can be optimized, the catalytic reactor body typically has a low pressure drop. In embodiments, the reactor body has a pressure drop of 0.5 bar or less per meter of the reactor body measured in the direction of the main fluid flow, measured using an air flow with a superficial gas velocity of 0.11 m/s and a temperature of 293 K. Preferably, the pressure drop is 0.4 bar per meter or less, more preferably 0.3 bar per meter or less.

Directing of the fluid in a direction at least partly transverse to the main flow direction of the reactor body results in an increase in turbulence in the fluid flow through the reactor body. This is beneficial, because it increases contact between the reactants in the fluid flow and the catalytically active internal surface area of the reactor body.

The extent to which turbulence is added to a fluid flow by the reactor body can be assessed by the classic experiment of Reynolds, in which a colored solution is introduced through a narrow tube to a fluid flow of a colorless liquid. This fluid flow with the colored solution is then passed through the reactor body. In order to analyze the percentage of turbulence, the homogeneity of the solution flowing out of the reactor can be inspected visually, to see the amount of turbulence added by the reactor body. If a homogeneously colored solution flows out of the reactor, the flow is considered to be 100% turbulent through the reactor body.

Analogously, the turbulence introduced by the reactor body to a gas flow can be measured by introducing locally into the gas flow a component that can be distinguished from the gas flow by gas chromatography. By taking samples from the fluid flow after it exits the reactor body, and analyzing the concentration of the introduced component, the amount of turbulence can be determined. If the concentration of the introduced component does not fluctuate over time, the flow through the reactor is 100% turbulent. Fluctuation over time in the concentration of the introduced component of 10% with respect to the highest measured value corresponds to a turbulence of 90%, etc. Preferably, the catalytic reactor body according to the invention makes a fluid flow 50% turbulent or more, preferably 70 % turbulent or more and more preferably 90% turbulent or more for a reactor body with a length along the fluid flow direction of 2 cm.

The extent to which the fluid is directed in a direction at least partly transverse to the main flow direction can for instance also be made visible by shining with a beam of visible light in the main flow direction. Such a beam of visible light cannot pass straight through a reactor body as described herein having a length along the main flow direction of 6 mm or more, preferably 4 mm or more and even more preferably 2 mm or more.

In embodiments, the catalytic reactor body of the invention can be provided as a disk. The disk may be produced by additive manufacturing and can be readily inserted within a reactor structure dealing with the flow of the reactants and the transport of the thermal energy. With the catalytic reactor body according to the invention, a short reactor can be used to achieve high conversion. Therefore, the disk may be relatively thin, i.e., the length in the main flow direction may be short relative to the diameter in the transverse direction of the disk. Preferably, the length of the disk along the main flow direction is shorter than the diameter along the transverse direction of the disk. In embodiments, the width/length ratio of the catalytic reactor body (i.e., the diameter in the transverse direction of the catalytic reactor body with respect to the main flow direction divided by the length of the disk along the main flow direction) is 1 or higher, more preferably 2 or higher. For instance, the width/length ratio of the catalytic reactor body can be in the range of 1-20, preferably in the range of 1.5-15, more preferably in the range of 2-10. In case a catalytic reactor body in the form of a short disk is deactivated, it can be easily exchanged or replaced by a fresh catalyst disk. Another advantage of these short disks is that they can be installed in places where not much space is available, for instance in consumers appliances, such as the stove pipe of a wood stove.

Another aspect of the invention is a stack comprising two or more catalytic reactor bodies connected in series. By stacking reactor bodies in series, the length of the catalytic reactor can be varied easily, for instance depending on the required conversion. Especially when the reactor bodies have a high width/length ratio, the length of the entire reactor can be controlled very accurately in small steps, and many different combinations of catalytic reactor bodies can be made.

Another advantage is that the exchange of deactivated disks can be performed very easily. In case only a few disks in such a stack of disks are deactivated, these disks can be exchanged by fresh disks, without having to replace or regenerate the complete catalyst bed. Alternatively, or additionally, if the stack comprising two or more catalytic reactor bodies is partially deactivated, one or more additional disks can be added in order to achieve the desired conversion, instead of having to replace or regenerate the entire reactor bed.

By combining multiple catalytic reactor bodies with different properties, such as different types of catalyst particles, different catalyst loadings, different sub-channel geometries, etc., it is possible to provide custom catalytic reactors in a convenient way. These reactors, which can for instance be provided in the form of a stack of disks, can also easily be adjusted, by adding, removing, or rearranging one or more catalytic reactor bodies. For example, a flow of reactants can first pass through a disk of a low loading of catalytically active species and with subsequent disks, where the concentration of reacting molecules is lower, the flow can pass a disk with a higher loading of active species. Especially when catalytic reactor bodies with a relatively high width/length ratio, for example thin disks, are used, customization of a reactor by combining reactor bodies with different properties may be controlled even more precisely.

Preferably, the catalytic reactor body as described herein further comprises one or more holes for receiving an alignment organ. In this way, the respective reactor bodies, for instance in the form of disks, in a stack comprising two or more catalytic reactor bodies can be aligned easily, in order to optimize the flow through the stack comprising two or more catalytic reactor bodies connected in series.

In embodiments, the catalytic reactor body further comprises one or more fluid inlets and/or outlets. Advantageously, using these fluid inlets and/or outlets, reactants and products can be brought into and removed from the catalytically active inner surface of the catalytic reactor body. Fluid inlets and outlets may be provided in the form of connectors to which a fluid line, for instance a gas line, can be connected. In case of a stack of disks, the first and the last catalytic reactor body of the stack of disk may be provided with a fluid inlet and outlet, respectively. By providing fluid inlets and/or outlets on the catalytic reactor body, it becomes convenient to incorporate one or more catalytic reactor bodies in an experimental or industrial setup, because fluid lines can be directly connected to the catalytic reactor body. Especially when the catalytic reactor body is made using additive manufacturing, it is very convenient to produce a catalytic reactor body with one or more fluid inlets and/or outlets already attached, because the inlets can be produced during the same additive manufacturing process with which the reactor body itself is made, without the need for extra steps of installing inlets and/or outlets.

An aspect of the invention is a method for the production of a catalytic reactor body according described herein, comprising the step of additive manufacturing of a body comprising a plurality of sub-channels.

Additive manufacturing of catalytic reactors can obviate the problems involved with the use of earlier reactors of sintered metal particles. Additive manufacturing makes it possible to produce reactor bodies having channels with optimized patterns that are typically not achievable by other methods such as sintering of metal particles, injection molding, or extrusion. For instance, channels with short sections in alternating directions can be produced using additive manufacturing.

Preferably, the pattern of the plurality of sub-channels is designed using computational fluid dynamics. By using computer programs dealing with computational fluid dynamics the pore widths and the flow pattern can be importantly optimized. As a result, the pressure drop over the reactor can be kept small, while the reactor body still provides a considerable internal surface area, as well as turbulence to a fluid flow.

Additive techniques that may be used include fused deposition modelling (FDM), selective laser sintering (SLS), selective laser melting (SLM), and material jetting of metal fluids. Other variance power fusion metal printing processes may also be used.

Fused deposition modelling can be performed for instance with direct nozzle deposition or multi-material nozzle deposition with combined material inlet like static mixing nozzles.

The recent development of additive manufacturing with highly filled polymers is very well suited for the production of catalytic reactor bodies according to the present invention. A large flexibility in materials and printing of layered structures is possible employing highly filled polymers. With printing with polymers filled with metal particles, the surface area per unit weight of the metal structure after removal of the organic material can be large. Deposition of one or more active components on the relatively large surface area leads to an active catalyst. Furthermore mixtures of metals and oxidic materials, such as, alumina, zirconia or titania, can be printed together with metals or alloys. Whereas the metal or alloy components can sinter by thermal treatment after oxidation of the polymers, the oxidic materials are maintaining a high surface area, which provides after deposition of a catalytically active component a high catalytic activity. Catalytic reactors produced by additive manufacturing with highly filled polymers are therefore an important embodiment of the present invention.

Therefore, in embodiments, the step of additive manufacturing comprises:
fused deposition modelling of a body using a polymer material comprising a metal and/or a ceramic material, and
treating the body to remove the polymer material and sinter the metal and/or ceramic material.

Treating the body to remove the polymer material and sinter the metal and/or ceramic material comprises for instance heating the body to a temperature at which the polymer material combusts or decomposes and at which the metal and/or ceramic material sinters.

Because additive manufacturing can be used to make complex structures, the sub-channel structure can be designed optimized and customized to a high degree. Preferably, the additive manufacturing step is preceded by designing an optimal sub-channel structure using computational fluid dynamics.

The method may further comprise applying an oxide layer onto the internal surface. This can be done for instance by impregnation of the internal surface of the reactor body with a solution comprising silicone rubber, and oxidizing the impregnated reactor body, thereby obtaining a silica layer covering the internal surface of the reactor body. In order to prevent plugging of the channels with the silica produced by oxidation of the silicone rubber, multiple impregnations with highly diluted solutions of silicone rubber can be executed. The silicone dioxide layer on the metal structure can be readily removed by treatment with an alkaline solution with most metals and alloys, which is attractive to rejuvenate catalysts after deactivation.

The method may also comprise a step of depositing a catalytically active component to the internal surface of the reactor body. This catalytically active component may be applied for instance as a thin layer, or as individual particles.

Depositing a catalytically active component to the internal surface of the reactor body may for instance be performed using electrochemical exchange, or by impregnation with a solution comprising one or more catalytic precursors, followed by drying and calcination.

The catalytically active component can be applied onto an oxide layer, but it has been established that also application of a catalytically active metal on a metal surface of the reactor body by electrochemical exchange surprisingly leads to a structure that is highly catalytically active. Application of copper on titanium, iron or nickel alloy surfaces is highly interesting, for instance also for the synthesis and decomposition of methanol. For oxidation of poisonous or badly smelling gases, specifically sulfur containing compounds (e.g. mercaptans), a very active composition was produced by electrochemical exchange of platinum or palladium.

In case the catalytic reactor body is formed of a metal, the method of manufacturing the reactor body may further comprise a step of controlled oxidation of the metal internal surface of the reactor body. This oxidation results in an oxide layer of an elevated surface area that is tightly connected to the underlying metal. This oxide layer may be catalytically active, and/or it can serve as a support for depositing catalytically active material. Such oxide layers can for instance be obtained by oxidation of titanium, zirconium and/or alloys thereof.

When the reactor or the reactor internal is produced from a metal or alloy that upon oxidation in oxygen produces an oxide layer of a high specific surface area strongly adhering to the metal, a catalytically active component can be applied onto the highly porous oxide layer. Application of an active component can be achieved according to procedures known in the art.

In embodiments, the method further comprises the steps of oxidation and reduction of the metal internal surface, thereby increasing the surface area of the metal internal surface.

Another aspect of the invention is the use of a catalytic reactor body as described herein for catalyzing a chemical reaction. The reactor body according to the invention can be used for a wide range of catalytic reactions, both endothermic and exothermic. Depending on the desired application, different materials and different ways of producing the reactor body can be chosen.

Another aspect of the invention is a method of catalyzing a chemical reaction in a catalytic reactor body as described herein.

According to an embodiment, the catalytic reactor body comprises hydrated iron oxide particles and is used for the oxidation of hydrogen sulfide and/or mercaptans from a gas flow.

An important application of the catalytic reactor body according to the invention is the oxidation of badly smelling gas molecules or other undesired gaseous impurities present in low concentrations in gas flows. Generally gas flows to be emitted in atmospheric air are involved. The content of the gas molecules to be removed is usually too small, to provide sufficient heat to keep the temperature of the reactor at a level required for virtually complete oxidation. To avoid using an extensive amount of thermal energy in the purification process, employing the thermal energy present in the gas flow after the combustion to rise the temperature of the gas flow into the reactor is required. Therefore, the catalytic reactor body according to the invention can be connected to another body, preferably a metal body, which is in thermal contact with the catalytic reactor body. The gas flow into the reactor can be preheated in that other body. This other body may for instance also be a reactor body as described herein, but without the catalytically active hydrated iron oxide particles.

Gas flows from plants where manure from e.g. pig farms is processed typically contain 1 to 200 ppm/v of hydrogen sulfide after removal of ammonia by treatment with acidic solutions.

The catalytic reactor body can also be used for partial catalytic combustion of ammonia, a process in which ammonia is catalytically converted into nitrogen and water. For the above case of a plant where manure from e.g. pig farms is processed or other places where livestock odor should be reduced, this means that catalytic reactor bodies according to the invention can be used for both removal of ammonia, as well as other badly smelling gases such as hydrogen sulfide and/or mercaptans. If desired, multiple catalytic reactor bodies containing different catalyst particles can be placed in series, for as instance in a stack of disks.

Another important application is the purification of natural gas from deposits of which the hydrogen sulfide content slowly increases. In these cases, the content of hydrogen sulfide and/or mercaptans is typically too small to employ the usual absorption in alkanol amines. The sulfur compounds are therefore removed by liquid or solid absorbents that are discarded as waste after saturation. Beside some liquid organic amines, hydrated iron oxides are generally utilized. The sulfur compounds react with the hydrated iron oxide to a sulfide that can be regenerated to hydrated iron oxide and elemental sulfur by exposure to oxygen at room temperature. Simultaneous regeneration can be easily performed by adding some oxygen to the gas flow to be purified. The process employing hydrated iron oxide dates from the nineteenth century when town gas was produced from coal. The problem is that the sulfur that is formed in the solid absorbent during the regeneration with oxygen remains in the absorbent, which raises the pressure drop over the absorbent bed. The removal of the spent absorbent from the reactor is labor-intensive and discarding of the absorbent saturated with sulfur is also difficult.

The special properties of catalytic reactor body according to the present invention brings about that a relatively short reactor is sufficient to remove impurities, such as hydrogen sulfide, completely. Small particles of hydrated iron oxide that are applied on the (internal) surface of the reactor body react rapidly with hydrogen sulfide and mercaptans and the oxidation with oxygen proceeds smoothly. The sulfur resulting from the oxidation remains on the surface of the catalytic reactor body. Due to the low pressure drop of the reactor large amounts of sulfur can be accommodated before the pressure drop becomes too high. Regeneration of the absorbent can be performed by heating the reactor during passing an inert gas flow, such as nitrogen, through the reactor. After condensation of the sulfur, the remaining gas flow, which contains a sulfur mist, can be brought into a flow of a combustible gas and fed to a burner, where the remaining sulfur is oxidized to sulfur dioxide. The small particles of iron oxide do not sinter during the thermal treatment due to the strong interaction with the surface of the reactor and are after rehydration again active in the uptake of hydrogen sulfide and mercaptans and oxidation of the sulfides.

Another catalytic process in which catalytic reactor bodies according to the invention can be used is methane steam reforming, a process in which methane and steam are converted into synthesis gas. Methane steam reforming is a very endothermic process. The excellent heat conduction of the catalytic reactor bodies according to the invention means that the catalyst can be heated effectively, e.g. using an external heater. When being used for methane steam reforming, it is preferred that the layer of a ceramic material comprises titanium dioxide, because titanium dioxide catalyst as a support material can be effective in suppressing coke formation during methane steam reforming. As explained above, such a layer can be prepared by controlled oxidation of the metal internal surface of the reactor body in case the reactor is made of titanium. Also, carbon dioxide reforming, calling for a higher temperature, can be performed, in which coke formation is suppressed.

Catalytic reactor bodies according to the invention can also be used to clean exhaust gases from combustion processes, such as wood combustion in a wood stove, for instance by oxidizing volatile organic compounds. In this way, air quality can be improved, for instance in residential areas. Advantageously, because of their low pressure drop, the catalytic reactor bodies can be installed in a stove pipe or chimney, without restricting the gas flow too much.

Catalytic reactor bodies according to the invention can also be used to clean gases that are collected by kitchen hoods. Similarly to the use in stove pipes or chimneys, the catalytic reactor body can for instance be installed in a vent pipe, or in the kitchen hood itself.

### EXAMPLES

### Example 1

In this comparative example 20 g of silica spheres were loaded with 0.5 wt.% Pd. To this end, the silica spheres were immersed in a 100 ml demineralized water solution which was brought to pH = 9 using an aqueous ammonia solution. Subsequently, 2.8 ml of an aqueous 10 wt.% tetraamminepalladium(II) nitrate solution was added dropwise to the solution. The solution was kept at pH = 9 for 24 h after which the impregnated silica spheres were separated from the solution by filtration and dried under ambient conditions for 2 h. Calcination was performed at 300° C. for 3 h to arrive at the supported palladium oxide catalyst.

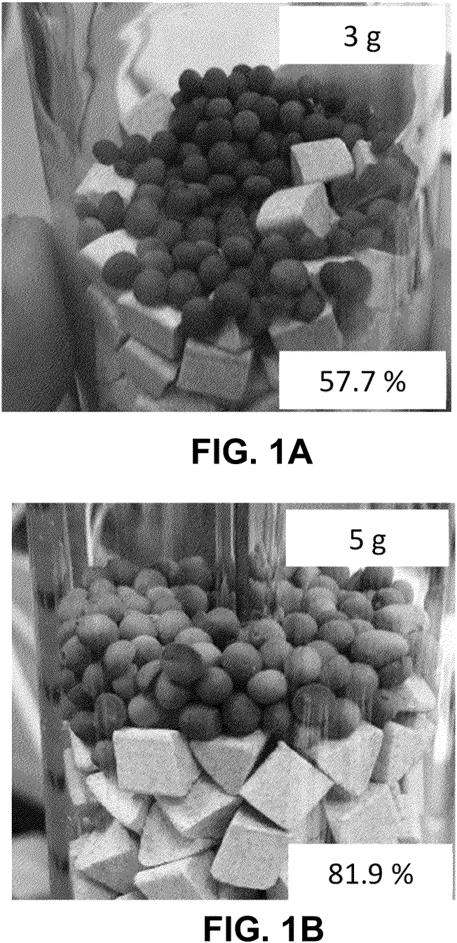

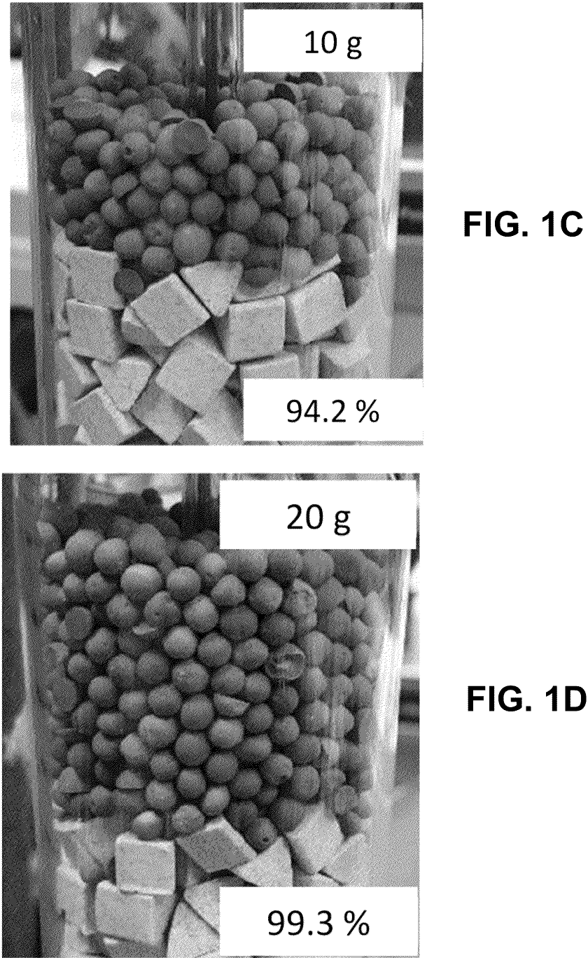

Catalytic oxidation of toluene with the prepared oxidation catalyst was performed in a glass fixed-bed reactor containing 3 g, 5 g, 10 g and 20 g of catalyst material, respectively. FIGS. 1 shows photographs of the fixed-bed reactor filled with the different amounts of catalyst material. The larger cubic bodies were added to raise the temperature of the gas flow into the reactor to the level of the experiment. Catalytic oxidation of toluene was performed by passing a flow of 400 l/h containing 300 ppm of gaseous toluene through the catalyst bed. Maximum conversion in all cases was achieved at a temperature of 275° C. In FIGS. 1, the amount of catalyst placed in the glass reactor and the maximum conversion achieved at 275° C. can be seen.

It is clear from the increasing maximum conversions, viz., 57.7%, 81.9%, 94.2%, and 99.3 %, with increasing amounts of catalyst material used, that a relatively large volume of catalytic material is required in the fixed-bed reactor to achieve the desired conversions of close to 100%. The use of smaller amounts of catalytic material results in a considerable slip of the reactants without reaction along the wall of the reactor, because the catalyst bodies are not well accommodated to the wall of the reactor. Consequently, the length of the catalyst bed must be relatively large to achieve the desired conversion.

### Example 2

Two sub-channel structures were designed and catalytic reactor bodies with these sub-channel structures were produced as a disk with a diameter of 4.4 cm and a length along the main flow direction of 2 cm. The characteristics of the two designs are listed in table 1. Structure 1 is shown in FIGS. 2, and structure 2 is shown in FIGS. 8.

In addition, two more disk with the same sheet pile design as disk structure 2, but with different disk diameter and thickness, were produced. The characteristics are also listed in table 1.

TABLE 1

Characteristics of different catalytic reactor bodies

| Characteristics | Disk structure 1 (zig-zag) | Disk structure 2 (sheet-pile) | Disk structure 3 (sheet-pile) | Disk structure 4 (sheet-pile) |
|---|---|---|---|---|
| Diameter (cm) | 4.4 | 4.4 | 9.3 | 24 |
| Thickness (cm) | 2 | 2 | 2.7 | 3 |
| Width/length ratio * | 2.2 | 2.2 | 3.44 | 8 |
| Inner surface area (design, cm²) | 278.1 | 378.8 | 1877.0 | 13635.9 |
| Inner surface area (estimated, cm², | 556.2 | 757.6 | 3754.0 | 27271.8 |
| factor × 2 due to surface roughness) | | | | |
| Volume disk (cm³) | 30.4 | 30.4 | 183.3 | 1357.2 |
| Surface area-to-volume cm²/cm³ | 18.3 | 24.9 | 20.5 | 20.1 |
| Wall thickness (mm) | 1.2 | 0.8 | 0.8 | 0.8 |
| Sub-channel diameter (rectangular cross section, mm × mm) | 1×4 | 2×6 | 2×6 | 2×6 |
| Angle of the channels (°) | 45 | 45 | 45 | 45 |
| Thickness of disk through which a beam of visible light cannot pass in the main flow direction (mm) | 4 | 5 | 5 | 5 |
| Tortuosity ** | 1.5 | 1.5 | 1.5 | 1.5 |
| Pressure drop (bar/m) *** | 0.12 | 0.10 | | |

* Diameter/thickness of the disk
** Tortuosity of the sub-channels, not related to possible porosity of the layer of ceramic material
*** Measured with a superficial flow velocity of 0.11 m/s in air at 20° C.

### Example 3

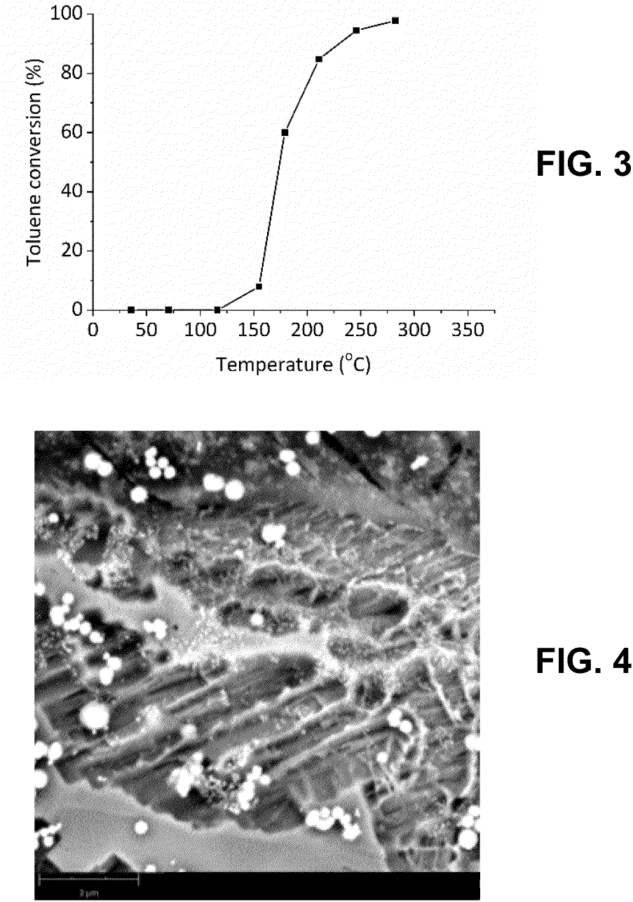

A 3D-printed stainless steel reactor disk containing reactor channels zig-zagging through the disk, was provided with a thin silicone rubber coating. To this end, a commercially available silicone rubber (Elastosil N10) was diluted 8 times (on a weight basis) with diethyl ether. The reactor disk was dip-coated for 5 s in the solution after which the silicone rubber was vulcanized for 4 h under ambient conditions. FIGS. 2A and 2B show the channel design of the reactor disk. FIG. 2C is a photograph of the 3D-printed disk, and FIG. 2D shows the disk after vulcanization of the silicone rubber coating. The disk was subsequently calcined at 550° C. (3 h) to convert the silicone rubber to a thin porous silica layer. To this silica layer a palladium catalyst was applied similarly to the procedure as described in example 1. The silica-coated reactor disk was immersed in an aqueous solution brought to pH = 9 with an ammonium hydroxide solution, after which 0.7 ml of a 10 wt.% tetraamminepalladium(II) nitrate solution was added dropwise to the solution. The solution was kept at pH = 9 for 24 h after which the disk was removed from the solution and dried for 2 h under ambient conditions. The disk was subsequently calcined at 300° C. for 3 h. The supernatant was analyzed with stripping voltammetry to determine the palladium loading of the reactor disk which was found to be 5 mg. Catalytic conversion of toluene using this reactor disk was performed at 400 l/h using 300 ppm toluene. The conversion curve is given in FIG. 3. From the conversion curve it can be seen that the toluene is converted up to 98% at a temperature of 275° C., although the amount of palladium used is 20 × lower than in comparative example 1. The improved conversion is believed to be caused by the design of the sub-channels and by the fact that short-circuiting of toluene along the wall of the reactor cannot occur due to the design of the reactor disk.

### Example 4

A reactor disk, 3D-printed from the titanium alloy Ti-6Al-4V with the same structure as shown in FIGS. 2 was thermally oxidized to introduce a titania support layer covering the inner surface. It was shown that a temperature between 600-700° C. was sufficient to provide a µm sized TiO₂-surface layer to the inner channels of the reactor disk which strongly adheres to the underlying Ti-6Al-4V alloy. Elemental analysis showed an enrichment of the surface with oxygen up to 68 wt.% of the sample oxidized at 700° C. At temperatures exceeding 800° C., the surface oxide layer became brittle and crack formation was observed. Using methods known in the art oxidation catalysts can be prepared on the oxidized surface layer (e.g. deposition precipitation, (citrate) impregnation, ion-exchange).

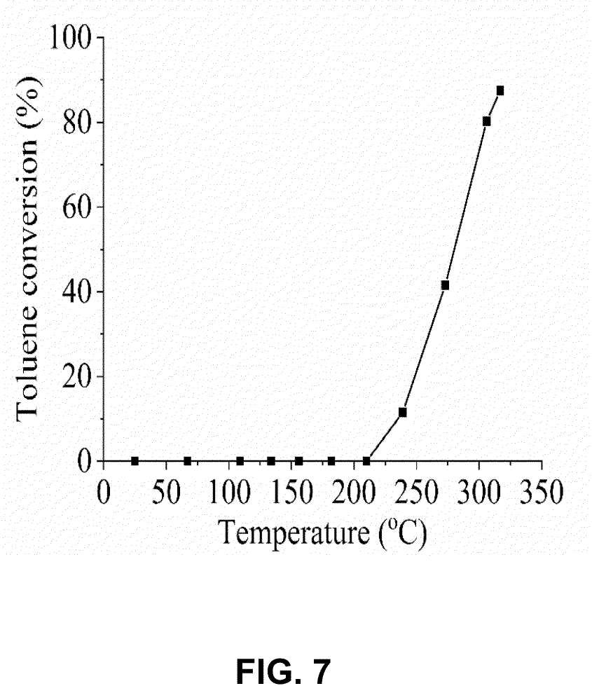

A 3D-printed Ti-6Al-4V alloy disk of structure 1 was thermally oxidized at 700° C. for 3 h with heating and cooling rates of 5° C./min. The disk was subsequently brought in 100 ml of a 14% HCl solution for 15 min, subsequently rinsed with deionized water and dried for 1 h at room temperature. The oxidized disk was subsequently placed in a solution containing 0.1 g tin(II) chloride and 0.03 g palladium(II) chloride in a hydrochloric acid solution of pH 1 (100 ml). Afterwards, the disk was transferred to a 100 ml deionized water solution containing 2.6 g ammonium chloride, 0.033 g palladium (II) chloride 1 g sodium hypophosphite, and 9.2 ml 14% HCl. The pH of the solution was brought above pH 10 by adding an ammonium hydroxide solution. The oxidized titanium disk was immersed for 1 h in this bath while stirring continuously with the bath temperature set at 75° C. Subsequently the disk was dried at room temperature (1 h) after which a drying procedure was carried out at 110° C. (overnight). Subsequently, calcination was performed at 450° C. for 3 h. The catalytic conversion of toluene was performed (400 ppm toluene, 400 l/h), the results are given in FIG. 7.

### Example 5

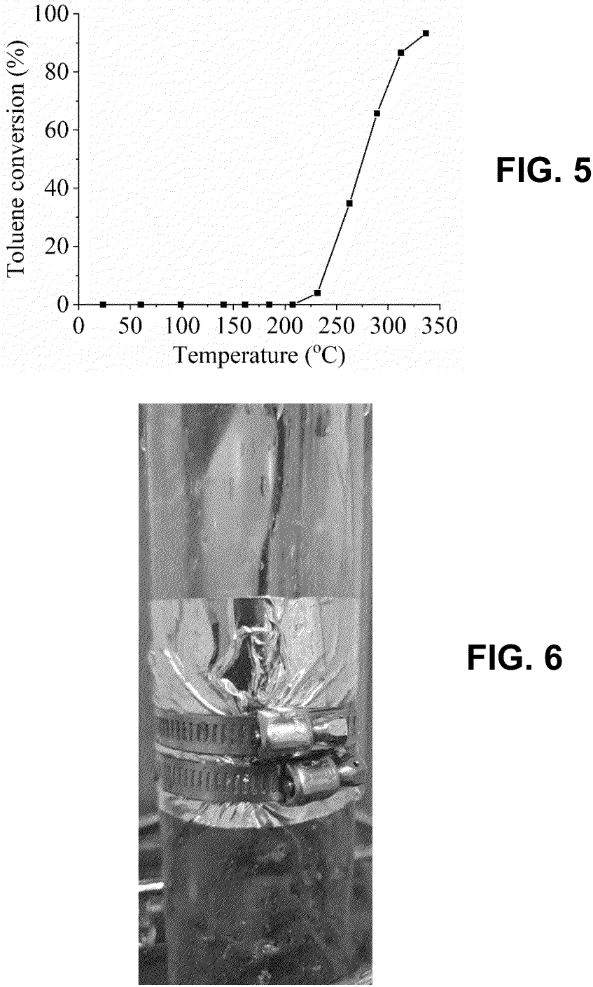

A stainless steel reactor disk as shown in FIGS. 2 was immersed for 1 h in a 1 M hydrochloric acid solution to partially remove the Cr₂O₃ surface oxide layer. After this acid treatment the reactor disk was directly transferred to a 1 M HCl solution containing platinum(II) chloride and palladium(II) chloride in a 1 to 5 ratio. The reactor disk was treated for 5 min in this solution for the galvanic exchange process to occur. The iron of the stainless steel substrate that was exposed due to the first acid treatment was oxidized while the palladium and platinum species became reduced onto the surface of the stainless steel due to their higher reduction potential in comparison with iron. After cleaning with demineralized water and drying, the prepared disk was used in the catalytic combustion of toluene. FIG. 4 shows a scanning electron microscopy (SEM) image taken with a back-scattered electron (BSE) detector in which the Pd/Pt catalyst are imaged as bright dots. The catalytic conversion curve using this disk is shown in FIG. 5, in which a conversion of 94% is reached at about 336° C.

### Example 6

Disk structure 2 (FIGS. 8) was 3D printed using an alternative 3D printing technique. Whereas the disk structure of FIGS. 2 was printed using a selective laser sintering procedure of a bed of powdered stainless steel, this example shows that the same structures can be produced using fused deposition modeling using a polymer containing metal particles. A polyoxymethylene polymer highly filled with stainless steel beads (ca. 80-90 wt.% stainless steel, commercial name BASF Ultrafuse 316L) was used as precursor. The filled polymer was printed via a heated extrusion nozzle (230° C.) into the sheet-pile structure of FIGS. 8. After a debinding (treatment with gaseous nitric acid at 120° C.) and sintering (hydrogen gas at 1380° C.) procedure the disk given in FIG. 8D was obtained, showing that these catalytic reactors can also be produced via a fused deposition modeling approach. The same structure obtained with SLS is shown for comparison in FIG. 8c.

### Example 7

A catalytic reactor disk was inserted in a vertical flow of water in an Osborne Reynolds setup. The diameter of the tube was 4.6 cm, to which the reactor disk was fitted, in such a way that water could not escape between the tube wall and the reactor disk. Water flowed through the disk with a flow rate of 1.2 l/min. Through the center of the tube a blue colored solution was introduced in the water flow (see FIG. 6). Due to the turbulence generated by the reactor disk, a homogenously blue colored solution exited the reactor disk (see bottom of FIG. 6).

### Example 8

A reactor constructed of titanium (Ti-6Al-4V) is coated with a silica layer by impregnation with a diluted solution of silicone rubber in ethyl acetate and after removal of the solution dried and calcined, according to the method described in US-A-5 472 927. To raise the thickness of the silica layer without plugging the pores of the reactor the impregnation and drying is repeated two times. Subsequently the reactor is filled with a dilute solution of iron(II) chloride and urea, after which the temperature is brought at 75° C., a temperature at which due to the hydrolysis of urea the pH of the solution increases and the iron(II) is deposition-precipitated on the silica. After removal of the remaining solution, drying and calcination, the reactor is ready to accept the sulfur. A flow of 200 ppm/v of hydrogen sulfide in air is passed through the reactor. With paper impregnated with lead acetate it was established that the hydrogen sulfide was completely taken up. After continuing the flow for 16 h the pressure drop was still small.

After changing the gas flow to nitrogen the temperature of the reactor was raised to 250° C. and the evolving sulfur was condensed by cooling the exhaust tube; the remaining gas flow was passed into a methane-air burner.

After cooling, the reactor was kept at 80° C. and a flow of steam was passed through the reactor, the absorbent kept at room temperature again reacted with hydrogen sulfide.

### Example 9

The conversion of toluene over a catalytic reactor body according to an embodiment of the invention (in the form of disks with a sheet-pile design), was compared to the conversion of toluene over a monolithic car catalytic converter. In table 2, the characteristics of the different catalysts are given. The catalytic car converter that was used was a commercially available catalyst with square straight channels with 400 channels per square inch, containing platinum, palladium and rhodium as catalytically active materials.

The disks according to the invention were 3D printed from stainless steel, and provided with a thin silicone rubber coating. To this end, a commercially available silicone rubber (Elastosil E43) was diluted 8 times (on a weight basis) with diethyl ether. The reactor disk was dip-coated for 5 s in the solution, after which the silicone rubber was vulcanized for 2 h under ambient conditions. This procedure was repeated three times. The disk was subsequently calcined for 3 h at 550° C. to convert the silicone rubber into a thin porous silica catalyst support layer. Onto this silica support a platinum/palladium bimetallic catalyst was deposited. The silica coated reactor disk was immersed in an aqueous solution which was brought to pH 10.5 using an ammonium hydroxide solution, after which 13 mg of tetraammineplatinum(II) nitrate and 325 mg of a 10 wt.% aqueous tetraamminepalladium(II) nitrate solution was added. The solution was kept at pH = 10.5 for 24 h. Afterwards, the disk was removed from the solution and dried for 2 h under ambient conditions. The disk was subsequently calcined at 300° C. for 3 h. After cooling, the catalyst application was performed for a second time to increase the catalyst loading. Per disk a catalyst loading of 36.3 mg was achieved.

TABLE 2

Characteristics of the reactors used in example 9

| | Catalytic car converter | Sheet pile disk |
|---|---|---|
| Material | Cordierite | Stainless steel 316L |
| Diameter (width) (mm) | 9.5 | 9.3 |
| Thickness (length) (mm) | 15 | 2.7 |
| Width/length ratio | 0.63 | 3.44 |
| Inner surface area (design, cm²) | 34320 | 1877.0 |
| Inner surface area (estimated, cm², factor × 2 due to surface roughness) | unknown | 3754.0 |
| Volume (cm³) | 1063 | 183.3 |
| Surface area-to-volume ratio | 32.3 | 20.1 |
| Wall thickness (mm) | 0.1 | 1.2 mm |
| Pore diameter (mm) | 1.3 | rectangular cross section 2 × 6 mm |
| Angle of channels (°) | 0 | 45 |
| Thickness of disk through which a beam of visible light cannot pass in the main flow direction (mm) | - | 4 |
| Tortuosity | 1 | 1.5 |
| Catalyst loading (estimated) (g) | > 1 | 0.0363 |

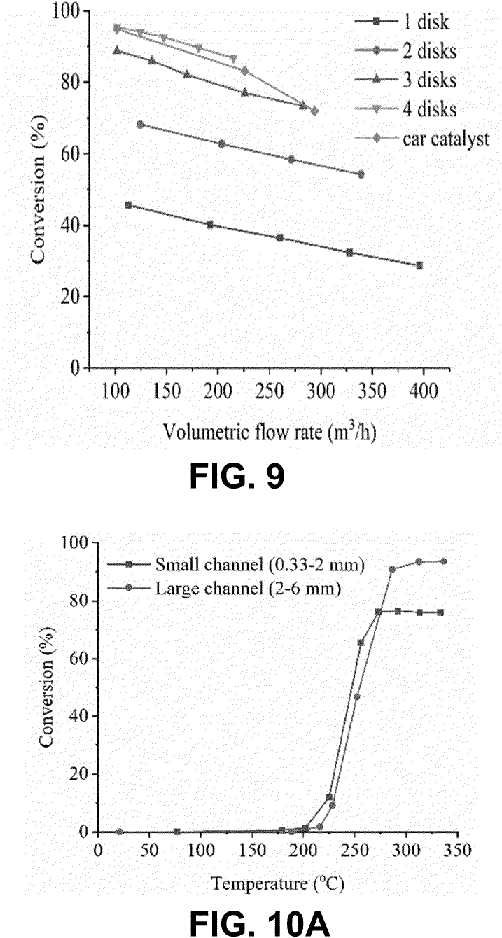

Catalytic conversion of toluene (100 ppm) was measured at various volumetric flow rates, in which the catalytic car converter was compared to a stack of a varying number of catalyst disks according to the invention (1-4 disks). The results are shown in FIG. 9. It can be seen that the conversion of toluene over a stack of 4 disks according to the invention was higher than when the catalytic car converter was used, even though the catalytic car converter has a higher reactor volume, higher internal surface area and much higher catalyst loading than the stack of 4 disks. The improved performance of the disks compared to the catalytic car converter is believed to be caused by the design of the sub-channels, such as the sub-channel structure, tortuosity and sub-channel diameter, resulting in improved contact of the reactant with the catalyst surface.

### Example 10

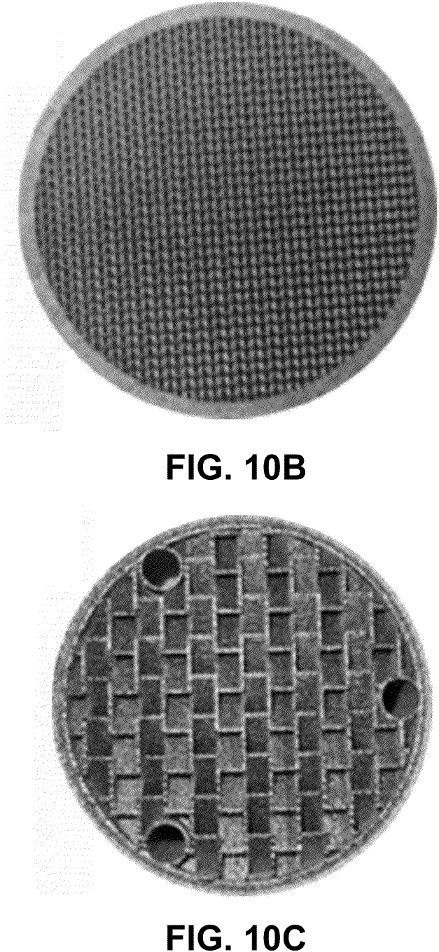

The conversion of toluene was compared for two stainless steel catalytic reactor bodies with the same sub-channel design (sheet pile) but with a different wall thickness and sub-channel diameter. Photographs of the different disks are shown in FIG. 10b (narrower sub-channels) and FIG. 10c (wider sub-channels). The main differences between the disks are the wall thickness of the sub-channels (0.1 vs. 0.8 mm), pore diameter (pores with a rectangular cross section of 0.33 mm × 2 mm vs. 2 mm × 6 mm) and internal surface area (1578.6 vs. 378.8 cm²). Both disks were provided with Pd/Pt catalysts, in the same way as described in example 9. Subsequently, the catalytic conversion of toluene was performed by passing a flow of 400 l/h containing 300 ppm of gaseous toluene through the different catalyst disks. Results are shown in FIG. 10a. Using the catalyst disk with the wider sub-channel diameters, a conversion of 93% was reached at 300° C. Surprisingly, with the catalyst disk with smaller sub-channels, a lower overall conversion was reached with a maximum conversion of 76%, despite the higher internal surface area and higher catalyst loading. Without wishing to be bound by theory, it is believed that in the disk with the narrower sub-channels laminar flow is more likely to occur due to the small dimensions of the channels. Therefore, less collisions with the active surface area will occur, resulting in a lower overall conversion.

### Example 11

A stainless steel catalyst disk containing a Pd/Pt catalyst, prepared in the same way as in example 9 was placed above a fire stove with a burning wood fire. The composition of the gas passing through the catalyst disk was monitored using a photo-ionization detector. When the temperature of the catalyst disk reached 300° C., the total volatile organic content of the air after passing through the catalyst disk was ca. 67% lower than before (60 vs. 20 ppm), showing the possibility of the catalyst disk to be used in cleaning exhaust gases of wood fire, by further oxidizing the incompletely combusted wood.

### Example 12

A stainless steel catalyst disk according to an embodiment of the invention (4.4 cm in diameter, 2 cm in length) containing a bimetallic Pd/Pt catalyst was used in the partial catalytic combustion of ammonia into nitrogen and water. A flow of 400 l/h containing 300 ppm of ammonia was led through the catalyst disk. At a temperature of 316° C., a conversion of 92% to nitrogen and water was achieved.

1. A catalytic reactor body, comprising a circumferential reactor wall extending in a main fluid flow direction of the reactor body between a reactor inlet and a reactor outlet thereby forming a channel for conducting a fluid; and a reactor bed arranged in the channel and being integrally formed with the circumferential reactor wall, wherein the reactor bed forms a plurality of sub-channels for guiding the fluid from the reactor inlet to the reactor outlet, each sub-channel defining a predetermined fluid path between the reactor inlet and the reactor outlet and being configured for directing the fluid in a direction at least partly transverse to the main flow direction.

2. The catalytic reactor body according to claim 1 wherein the reactor body comprises or consists of metal.

3. The catalytic reactor body according to claim 2, wherein the catalytic reactor body comprises an internal metal surface covered by a layer of a ceramic material.

4. The catalytic reactor body according to claim 1, wherein the reactor body comprises or consists of a ceramic material.

5. The catalytic reactor body according to claim 1, wherein catalyst particles are deposited on the internal surface of the catalytic reactor body.

6. The catalytic reactor body according to claim 1, wherein the reactor body is made by additive manufacturing.

7. The catalytic reactor body according to claim 1, wherein the sub-channels comprise a section oriented at an angle of 20 to 70 degrees with respect to the main flow direction.

8. The catalytic reactor body according to claim 1, further comprising one or more secondary sub-channels arranged for accommodating a second fluid.

9. The catalytic reactor body according to claim 1, further comprising one or more holes for receiving an alignment organ.

10. The catalytic reactor body according to claim 1, having a length in the direction of the main fluid flow of 0.5 to 50 cm.

11. The catalytic reactor body according to claim 1, wherein the ratio between the width of the catalytic reactor body transverse to the direction of the main fluid flow and the length of the catalytic reactor body in the direction of the main fluid flow is 1 or higher.

12. The catalytic reactor body according to claim 1, wherein the sub-channels have a tortuosity of 1.1 or higher.

13. The catalytic reactor body according to claim 1, wherein the diameter of the sub-channels is 1 mm or higher.

14. The catalytic reactor body according to claim 1, wherein the internal surface area of the reactor body has an S_{dr} parameter of 0.5 or more.

15. The catalytic reactor body according to claim 1, wherein the volume of solid material relative to the total volume of the catalytic reactor body is 0.7 cm³ per cm³ or less.

16. The catalytic reactor body according to claim 1, having a pressure drop of 0.5 bar or less per meter of the reactor body measured in the direction of the main fluid flow using an air flow with a superficial gas velocity of 0.11 m/s and a temperature of 293 K.

17. A stack comprising two or more catalytic reactor bodies according to claim 1 connected in series.

18. The stack according to claim 17, wherein the reactor bodies are aligned with an alignment organ.

19. A method for the production of a catalytic reactor body according to claim 1, comprising the step of:
additive manufacturing of a body comprising a plurality of sub-channels.

20. The method according to claim 19, wherein the step of additive manufacturing comprises fused deposition modelling, selective laser sintering, selective laser melting, and/or material jetting of metal fluids.

21. The method according to claim 19, wherein the step of additive manufacturing comprises:
fused deposition modelling of a body using a polymer material comprising a metal and/or a ceramic material, and
treating the body to remove the polymer material and sinter the metal and/or ceramic material.

22. The method according to claim 19 preceded by the step of:
designing an optimal sub-channel structure using computational fluid dynamics.

23. The method according to claim 19 followed by the steps of:
impregnation of the internal surface of the reactor body with a solution comprising silicone rubber, and
oxidizing the impregnated reactor body, thereby obtaining a silica layer covering the internal surface of the reactor body.

24. The method according to claim 19, further comprising the step of:
depositing a catalytically active component to the internal surface of the reactor body.

25. The method according to claim 24, wherein depositing a catalytically active component to the internal surface of the reactor body is performed using electrochemical exchange, and/or by impregnation with a solution comprising one or more catalytic precursors followed by drying and calcination.

26. The method according to claim 19 wherein the catalytic reactor body is formed of a metal, further comprising the step of:
controlled oxidation of the metal internal surface of the reactor body.

27. The method according to claim 19, further comprising the step of:
oxidation and reduction of the metal internal surface or catalytically active metal internal surface, thereby increasing the surface area.

28. A method for catalyzing a chemical reaction, said method comprising contacting a chemical with a catalytic reactor body according to claim 1 or a stack according to claim 17.

29. The method according to claim 28, wherein the catalytic reactor body or stack comprises hydrated iron oxide particles and wherein the chemical reaction is the oxidation of hydrogen sulfide and/or mercaptans from a gas flow.

30. The method according to claim 28, wherein the catalytic reactor body or stack is present in an exhaust pipe of a combustion process.

31. The method according to claim 28, wherein the catalytic reactor body or stack is used for the production of synthesis gas from a hydrocarbon.
